(19) United States
(12) Patent Application Publication
(10) Pub. No.: US 2006/0074781 A1
(43) Pub. Date: Apr. 6, 2006

(54) System for facilitating turnkey real estate investment in Mexico

(76) Inventors: Hector V. Leano, Anaheim, CA (US); Hector G. Leano, Anaheim, CA (US)

Correspondence Address: Hector V Leano;Hector G Leano, PO Box 8487, Anaheim, CA, 92812, US

(21) Appl. No.: 10/711,805

(22) Filed: Oct. 6, 2004

(51) Int. Cl. G06Q 40/00

(52) U.S. Cl. 705/35

(57) ABSTRACT

The present invention provides a system of establishing a secure marketplace for the development of real estate projects in Mexico at a competitive price. Particularly, this invention involves a system where investment opportunities for Mexican projects are offered to individuals such as an investor with credit or capital residing in the United States. This method involves compiling data that includes the project, investment incentives and financing options for the investor. This system will maximize the ability to reach potential consumers as well as create investment opportunities in Mexico.

### BACKGROUND OF INVENTION

This invention relates to the field of using a computer network to securely initiate and implement investments by U.S. residents into real estate development projects in Mexico.

Economic factors indicate that the ownership of real property in Mexico is becoming a popular form of investment for U.S. residents. Parts of Mexico such as Guadalajara, Jalisco have had real property appreciation increases comparable to premium U.S. regions such as Orange County. For example, the value of real estate in Guadalajara, Mexico and Orange County, Calif., USA has tripled their original value between 1983 and 2003. Mexican leisure resorts such as Cabo San Lucas now rival Hawaii as the top destination for U.S. tourists.

American investment in Mexican real estate is something the Mexican and American governments want to advance for two reasons: It has the potential to bring an amount of new capital into Mexico and it can help reduce the flow of immigrants into the U.S.

Statistics show that a high percentage of Latinos in the U.S. own their homes. Latinos are largest minority in the U.S. and most are of Mexican descent. If just a fraction of this demographic would use the equity from their American homes to purchase Mexican property, the resulting windfall for Mexico could surpass income from remittances, a top source of Mexico's economy. This type of financing is simple in the U.S. compared to Mexico where credit is scarce.

There are many opportunities to purchase real property in Mexico. Coastal destinations in Baja Calif. Norte just minutes across the border from San Diego offer homes with similar, spectacular views as American, beach front houses of California that are priced up to 30 times more than their Mexican counterparts. Additionally, many Americans of Mexican descent desire to go back to Mexico for leisure, work, study or retirement.

Unfortunately, despite the appeal of purchasing or investing in real property in Mexico, it is still risky for U.S. residents to do so. Even diligent investors who spend much time, money and resources have problems with securing their investment. U.S. based investors are prone to misinformation and mismanagement due to the variety of available Mexican real estate advice. The law in Mexico allows people to dispute home ownership regardless of what phase the sale process is in. Despite recent reforms to protect investors from these problems, Americans are still confronted with the problem of leaving their Baja homes because they were improperly purchased.

Essentially it is possible to secure adequate protection when making these kinds of investments. Mexican law allows for the same protective measures that exist in the United States. For example, it is possible for a U.S. resident to process in Mexico a fideicomiso—the Mexican equivalent to a fiduciary trust. Also it is possible to obtain title insurance in Mexico. In light of this, there is a need for a system that adequately exposes U.S. residents to the legal instruments available for entering into secure investments for Mexican real estate projects.

Systems that streamline US-Mexico cross border business relationships have been patented. U.S. Pat. No. 6,526,443 entitled, Method and apparatus for managing transactions with connected computers, concerns a system that facilitates the management of complex transactions associated with the transshipment of goods across the U.S.-Mexican border. This disclosure identified the complexity of adequately preparing for cross border transport given the amount of paper work associated with the numerous regulatory documents that typically require knowledge in both Spanish and English. As a result this patent relates to a computerized system comprising a collaborative architecture that improves the efficiency of this process.

Like U.S. Pat. No. 6,526,443, there is also a need to streamline the investment of funds across the U.S.-Mexican border for the development of real estate projects. The disclosed embodiment relates to a turnkey system consisting of a network containing access to key components necessary in successfully funding real estate development projects or purchasing real estate in Mexico.

The present invention comprises a network that comprehensively coordinates the numerous facets associated with investing in Mexican real estate. This network provides a means of listing real property that is available for investment. The network will list the steps necessary to enter into a secure investment. These steps will also include listings of professionals that provide services related to the investment. The invention also provides a means for securing transferring funds into Mexico.

This system further entails a marketplace that enables contractors and investors to negotiate the costs associated to the acquisition of a Mexican real estate project. Professional service providers and building contractors will be able to identify pending project proposals and be allowed enter bids regarding how much they would charge to perform a particular services. Insurance providers can also list their prices and other details of insurance plans through this network. As a result the investor will be able to make informed decisions regarding the investment opportunity in a format the adequately protects against the risks associated with these types of investments.

Advantages and novel features will become apparent to those skilled in the art upon examination of the description or may be learned by practice of the invention. The objects and advantages of the invention may be realized and attained by means of the instrumentalities and combinations particularly pointed out in the appended claims.

### SUMMARY OF INVENTION

This invention is a focused marketing system that secures the real estate investment process in Mexico. The invention relates to a system that targets United States residents about investment opportunities in Mexican real estate projects. This proposal includes information associated with investing in Mexico. More particularly, the disclosed system constitutes one source where residents in the United States can view investment opportunities for projects in Mexico, identify incentives in investing and choose amongst investment financing plans.

### BRIEF DESCRIPTION OF DRAWINGS

FIG. 1 is a general description of the embodied invention.

FIG. 2 illustrates the chronology associated with entering into an investment contract FIG. 3 illustrates how investment opportunities are introduced into the network.

FIG. 4 is a diagram of building contractor contract negotiations.

FIG. 5 is a diagram of professional service provider contract negotiations.

FIG. 6 illustrates how the cost of the investment opportunity is determined.

FIG. 7 illustrates the how money is transferred to the contracting parties.

### DETAILED DESCRIPTION

The present invention provides a means of establishing a system for facilitating real estate investment in Mexico. Aspects of the preferred manner of practicing the present invention are shown by the accompanying drawings. While the present invention will be described more fully hereinafter, it is to be understood at the outset of the description which follows that persons of skill in the appropriate arts may modify the described invention while still achieving the favorable results of this invention. Therefore, the following description is to be understood as being a broad, teaching disclosure directed to persons of skill in the appropriate arts, and not as limiting upon the present invention.

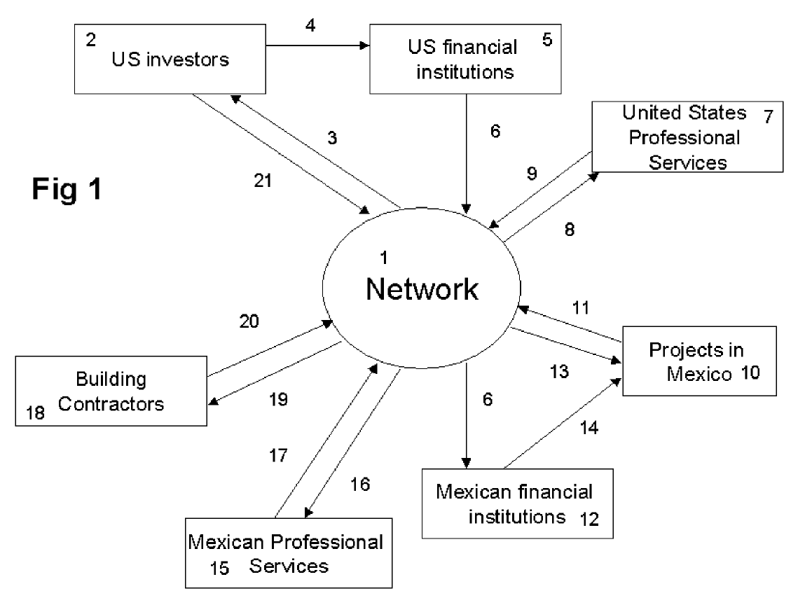

FIG. 1 is a broad illustration of the disclosed real estate investment system. Quality investment opportunities and related services associated with these transactions are communicated through a network (1), which will have appropriate standards so that all elements within are trustworthy. The network (1) can be defined or changing in size and composition of participants. The network (1) can be a computer-based system consisting of one or multiple computers. The computers will contain compiled data relating to the investment opportunities that can be accessed by people interested in entering into contacts. Another preferred embodiment is that the network can be any coordinated referral system that results in a turnkey real estate investment in Mexico by U.S. investors This real estate investment system provides a network (1) where investors who are residents of the United States (2) can access real estate projects in Mexico that are available for investment (3). In this case, projects in Mexico (10) can list investment opportunities (11) to investors residing in the U.S. (2). The projects (10) are managed by one or many project managers. The listing of investment opportunities (11) can be done through any effective advertising medium including but not limited to: the Internet, television, radio, newspapers, newsletters, telephone solicitations and mass mailing. U.S. investors (2) can alternatively propose real estate projects (21) through the network (1) in Mexico that they are willing to invest in.

In situations where the U.S. investor (2) realizes through the network that the product meets his or her requirements and wants to make an investment into a project, the investor (2) can request (4) his/her financial institution (5) to access saved capital or untapped home equity in the U.S. or Mexico and wire funds (6) into a financial institution in Mexico (12) that funds the real estate development project (14) The investor's financial institution (5) includes U.S. financial institutions as well their Mexican subsidiaries and affiliates.

In a preferred embodiment, this real estate investment network (1) is also a medium where building contractors (18) can enter into contracts relating to the real estate project. The building contractors (18) can be associated with architecture, planning, supervision, labor and material. The contractors (18) can either be residents of Mexico or the United States. The contractors (18) can access (19) the network (1) to find opportunities to work on real estate projects (10). The contractors (18) can enter bids (20) regarding their fees for performing services. The Mexican real estate project (10) or investor (2) can then access these bids (13) in selecting the most competitive offer.

Professionals (7) and (15) providing services in real estate contracts can offer and enter into contracts to provide services associated with developing real estate projects in Mexico (10). In this aspect of the present invention, a professional service provider in the United States (7) can access investment opportunities (8) through the network. The U.S. professional service provider (7) can offer services (9). The type of services offered by the U.S. professional service providers (7) include and not limited to: mortgage brokers, lenders, financial service providers, tax advisors, real estate brokers, property managers, title insurance as well as attorneys. These services could be a necessary prelude before any funds are wired into project purchase or construction. For example, sometimes research on property, title and deed unearths conditions of disputed ownership, making the land undesirable for purchase or development. Mechanisms such as title insurance through third party escrow agreements can help guarantee initial deposits or ownership rights if investor is sued in the future. In another preferred embodiment, Mexican professional service providers (15) can access (16) the network (1) to identify opportunities associated with real estate investment opportunities. The professional can then offer services (17) associated with the Mexican real estate project (10). The types of services offered by Mexican service providers (15) include and are not limited to: legal, accounting, notary, insurance, real estate brokers, property management, financial and other consulting. Most of these services are necessary before initiating the purchase of real estate or construction of a project. The Mexican real estate project (10) or investor (2) can then access the offers (13) by the professional service providers (7) and (15) and select the most competitive offers.

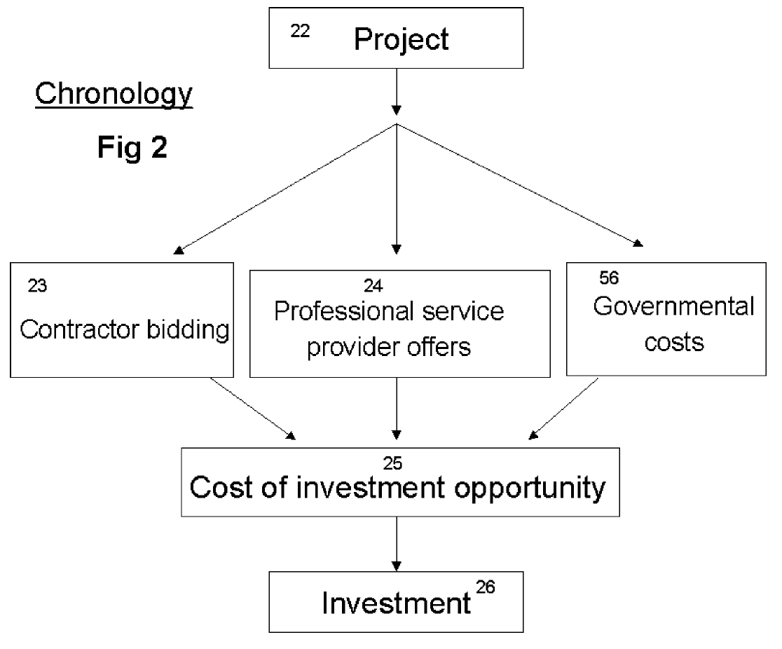

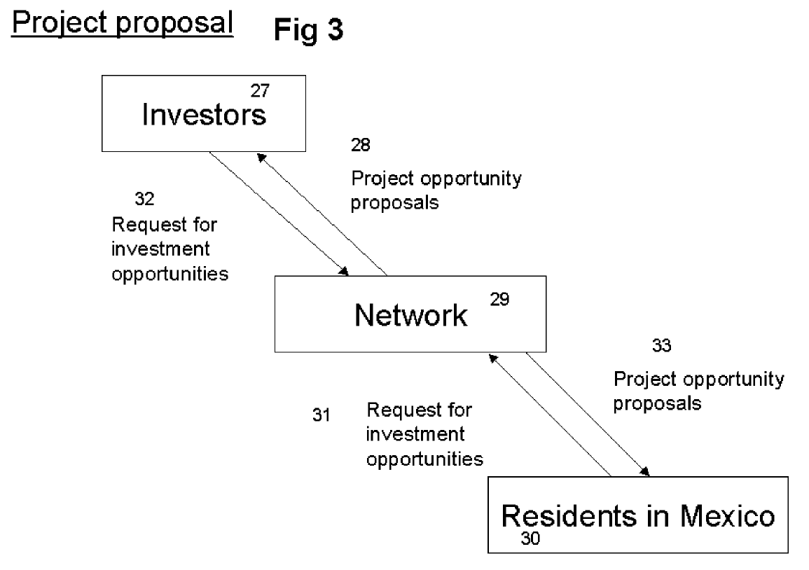

FIG. 2 outlines the chronology associated with entering into investments for real estate projects in Mexico in accordance with the described invention. Projects (22) are presented. In a preferred embodiment, investors residing in the United States can list projects (22). In another preferred embodiment, the projects can be listed by people residing in Mexico interested in developing real estate in Mexico. After a project (22) is listed, building contractors (23) and professional service providers (24) can present offers to work on jobs associated with the project (22). Additionally, Mexico and U.S. government fees (56) are also calculated. After collecting these costs, the cost of the investment opportunity (25) is then calculated. The investment opportunity cost (25) is then communicated to U.S. based investors who then decide on whether to make an investment (26).

A more detailed description of the described invention regarding how projects opportunities are presented over the network (29) is diagrammed in FIG. 3. In one preferred embodiment, investors residing in the United States (27) can use the system to access project opportunities that are available for investment (28). In another preferred embodiment, U.S. investors (27) can request (32) real estate projects that are available for investment. In another preferred embodiment, people residing in Mexico (30) can make requests (31) for investment into real estate projects. In another preferred embodiment, residents in Mexico can access project opportunities (33) published through the described invention.

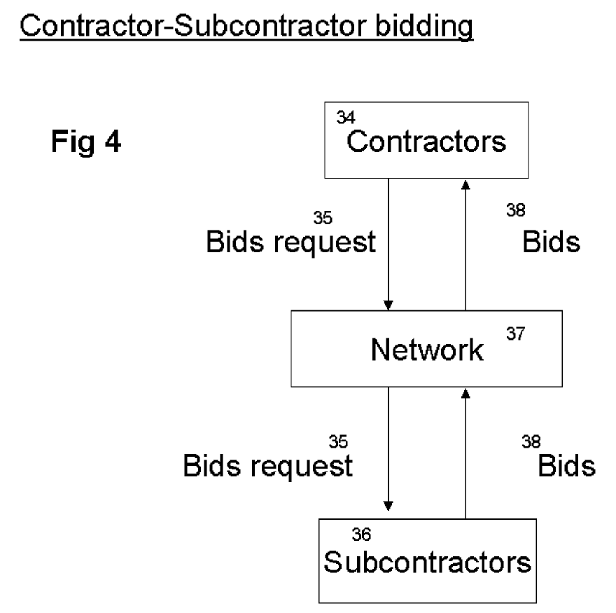

In the case of building contracts, contractors typically subcontract tasks to subcontractors. This generally occurs before the contractor makes a bid for the building contract. A preferred embodiment of the described invention also includes this contractor-subcontractor relationship. This is diagrammed in FIG. 4. In this embodiment, the contactor (34) solicits bids (35) from subcontractors (36) for specific tasks regarding the building contract through the network (37). The types of jobs include and are not limited to roofing, flooring, plumbing, masonry, carpentry, electrical, tiling, materials and design. The subcontractors (36) can enter bids (38) for specific jobs into the network so that the contractor (34) can choose the most competitive bids.

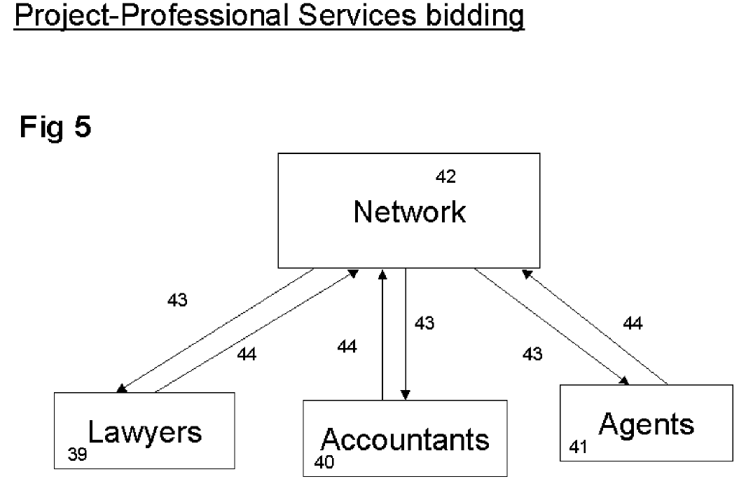

The present invention also provides a network for the bidding of professional services contracts. This is illustrated in FIG. 5 where examples of the types of service professionals include but are not limited to: lawyers (39), accountants (40) and agents (41). In this case, requests for bids (43) are accessed over the network (42). Professional service providers can then enter bids (44) into the network (42).

The disclosed system of investing into real estate projects in Mexico provides a means of determining the costs associated with undertaking a real estate development project. Since these types of contracts consist of many subcontracts, it can get difficult to calculate the total costs of the project. Additionally it is also difficult to determine what contracts need to be entered into as well has how to enter into these contracts, mostly due to the cross border nature of these investments. The system described in the present embodiment is designed to facilitate streamlining this process by listing the necessary services for these types of investments as well as the parties that provide these services.

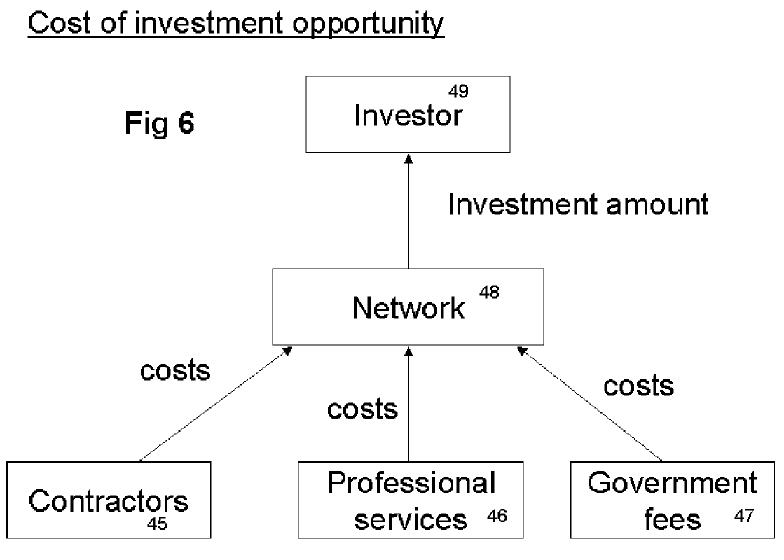

FIG. 6 outlines how the cost of the investment is calculated. In order for this to be determined, the costs associated with the building contractors (45), professional service providers (46) and government service providers both in Mexico and the U.S. (47) are entered into the network (48) that is then accessed by the potential investors residing in the United States (49). As a result the investor knows definitely all the costs and requirements associated with the development of the building project as well as all the types of services that need to be entered into when making this investment.

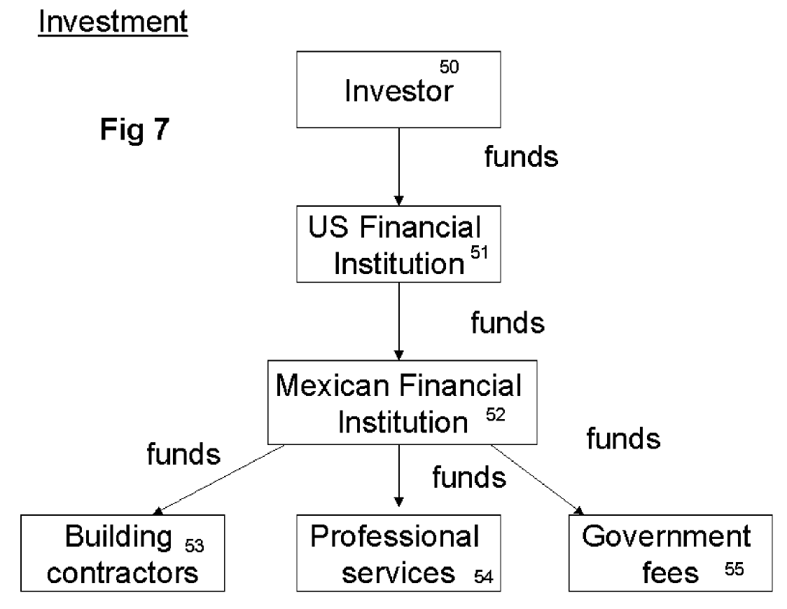

Another preferred embodiment of the present invention is establishing a system that streamlines the payment process. This embodiment is illustrated in FIG. 7. Here the investor (50) through his/her financial institution (51) in the United States wires funds to a Mexican financial institution (52) that then distributes the money to the building contractors (53), professional service providers (54) and government fees (55).

What is claimed is:

1. An apparatus to facilitate, for U.S. residents, turnkey real estate investment transactions in Mexico comprising a network consisting of:
a. information about Mexican real estate development projects available for investment,
b. information about U.S. financial institutions,
c. information about Mexican financial institutions,
d. information about building contractors,
e. information about professional service providers,
f. information about governmental services
g. information about governmental requirements
h. quality control of network participants and
i. information about features desired by potential investors.

2. The network of claim 1 consisting of:
a. a plurality of computers,
b. a network connecting said computers and
c. software controlling the operation of the plurality of computers.

3. The network of claim 1 consisting of any coordinated referral system that results in a turnkey real estate investment in Mexico by U.S. investors.

4. The network of claim 1 wherein said network can be accessed by:
a. U.S. residents with available capital or credit to make investment in Mexico,
b. real estate project managers,
c. building contractors,
d. professional service providers,
e. U.S. financial institutions and
f. Mexican financial institutions.

5. The network of claim 1, wherein real estate investment opportunities are provided to said U.S. residents after a need and supply analysis is conducted.

6. The network of claim 1, wherein real estate investment opportunities are provided said real estate project managers.

7. The network of claim 1, providing a means for entering into contracts regarding the real estate project.

8. The network of claim 1, wherein said building contractors can offer to enter into contracts.

9. The network of claim 1, wherein said professional service providers can offer to enter into contracts.

10. The network of claim 1, wherein said professional service providers are:
a. United States tax advisors,
b. Mexican tax advisors,
c. Mexican lawyers,
d. Mexican public notaries,
e. United States media,
f. Companies proving title insurance,
g. Property managers in Mexico and
h. real estate agents.

11. The network of claim 1, wherein said network provides a means of negotiating contracts relating to said investment opportunity.

12. The network of claim 1, wherein said U.S. resident negotiates contracts with:
a. said professional service providers,
b. said real estate project managers and
c. said building contractors.

13. The network of claim 1, wherein said project manager negotiates contracts with:
a. said U.S. resident,
b. said professional service providers and
c. said building contractors.

14. The network of claim 1, wherein said building contractor negotiates contracts with building sub contractors.

15. The network of claim 1, wherein said building contractors are:
a. architects,
b. planners,
c. supervisors,
d. laborers and
e. material providers.

16. The network of claim 1, wherein said network providing a means for said U.S. financial institution to transfer funds to said Mexican financial institution with real estate investment as a primary purpose.
